(19) United States
(12) Patent Application Publication
(10) Pub. No.: US 2018/0182207 A1
(43) Pub. Date: Jun. 28, 2018

(54) GAMING METHOD AND APPARATUS

(71) Applicants: Scott Huang, New Taipei City (TW); Pou-Hung Chen, New Taipei City (TW)

(72) Inventor: Scott Huang, New Taipei City (TW)

(21) Appl. No.: 15/852,463

(22) Filed: Dec. 22, 2017

(30) Foreign Application Priority Data
Dec. 27, 2016 (TW) 105143284

(51) Int. Cl. G07F 17/32

(52) U.S. Cl. CPC G07F 17/3223; G07F 17/3225; G07F 17/3288; G07F 17/3267; G07F 17/3216

(57) ABSTRACT

A gaming method is proposed to use a processor to start a first game and a second game associated with the first game. A physical probability unit is used in the second game to randomly generate a result output based on physics principle associated with a physical structure thereof. The result of the second game is associated with the result output generated by the physical probability unit.

### CROSS-REFERENCE TO RELATED APPLICATION

This application claims priority of Taiwanese Patent Application No. 105143284, filed on Dec. 27, 2016.

### FIELD

The disclosure relates to a gaming method and a gaming apparatus that employs a unit to generate a random result based on physics principles associated with a physical structure of the unit.

### BACKGROUND

Many traditional games such as sic bo, slot machines, roulette, etc., employ physical probability units (e.g., dices, spinning reels of the slot machines, spinning wheels of the roulette, etc.) to determine a game result associated with probability. Such games benefit in easy operation and high unpredictability, thereby catching players' interests.

However, with the development of computer technology, more and more such games use a computational algorithm for random number generation so as to determine a probability-based game result. Unlike the traditional games, where the player's mood goes up and down with operation of the physical probability units in the form of, for example, rolling of a dice, spinning of reels or a roulette wheel, etc., this new type of random number generation is not observable by the players, leading to lower attractiveness of the games. In addition, the players may have concerns over the fairness of the games that use computational algorithm to randomly produce the game results.

### SUMMARY

Therefore, an object of the disclosure is to provide a gaming method and a gaming apparatus that can alleviate at least one of the drawbacks of the conventional games that use computational algorithm to generate a probability-based game result.

According to the disclosure, the gaming method is to be implemented by a gaming apparatus that includes an input unit, a display unit, a processor, a camera unit, a storage unit, and a physical probability unit. The storage unit stores a first total score associated with a first game, and a second total score associated with a second game. The gaming method includes: step (a): in response to a bet value inputted via the input unit, the processor determining whether the bet value is greater than a predetermined threshold; step (b): when the processor determining that the bet value is greater than the predetermined threshold, the processor starting a procedure of the first game in response to a request for starting the first game from the input unit, followed by generating a first gaming result that is associated with the first game and that contains a first gaming score, and updating the first total score based on the first gaming score; step (c): the processor starting a procedure of the second game by activating the physical probability unit to randomly generate a result output based on physics principles associated with a physical structure thereof; step (d): the processor controlling the camera unit to capture an image or images of the result output generated by the physical probability unit; step (e): the processor generating a second gaming result that is associated with the second game and that contains a second gaming score based on the image or images captured in step (d), controlling the display unit to display the second gaming result, and updating the second total score based on the second gaming score; and step (f): the processor updating the first total score based on the second total score.

According to this disclosure, the gaming apparatus includes a storage unit, an input unit, a physical probability unit, a camera unit, a display unit and a processor. The storage unit stores a first total score associated with a first game, and a second total score associated with a second game. The input unit is for input operation by a user. The physical probability unit is configured to randomly generate a result output based on physics principles associated with a physical structure thereof. The camera unit is configured to capture the result output generated by the physical probability unit. The processor is electrically coupled to the storage unit, the input unit, the physical probability unit, the camera unit and the display unit. The processor is configured to, in response to a bet value inputted via the input unit, determine whether the bet value is greater than a predetermined threshold. The processor is configured to, upon determining that the bet value is greater than the predetermined threshold, start a procedure of the first game in response to a request for starting the first game from the input unit, followed by generating a first gaming result that is associated with the first game and that contains a first gaming score, and updating the first total score based on the first gaming score. The processor is configured to start a procedure of the second game by activating the physical probability unit to randomly generate the result output. The processor is configured to generate a second gaming result that is associated with the second game and that contains a second gaming score based on the image or images captured by the camera unit, control the display unit to display the second gaming result, and update the second total score based on the second gaming score. The processor is configured to update the first total score based on the second total score.

### BRIEF DESCRIPTION OF THE DRAWINGS

Other features and advantages of the disclosure will become apparent in the following detailed description of the embodiment(s) with reference to the accompanying drawings, of which:

FIG. 1 is a block diagram illustrating an embodiment of the gaming apparatus according to the disclosure;

FIG. 2 is a flow chart illustrating steps of a first exemplary implementation of the gaming method according to this disclosure;

FIG. 3 is a schematic diagram illustrating different implementations of a closed loop to be displayed on a second gaming screen according to this disclosure; and

FIG. 4 is a flow chart illustrating steps of a second exemplary implementation of the gaming method according to this disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

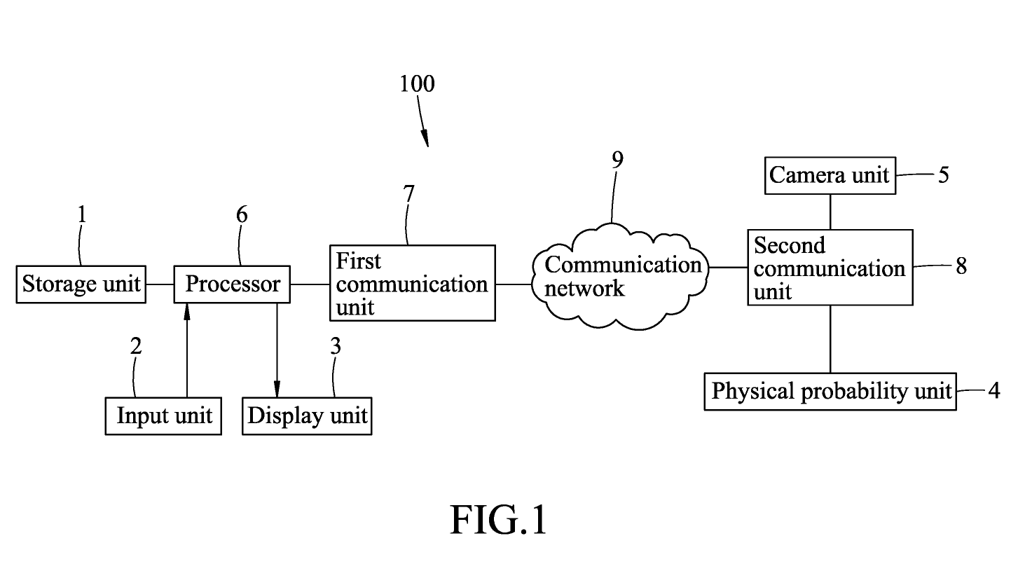

Referring to FIG. 1, the embodiment of the gaming apparatus 100 according to this disclosure is shown to include a storage unit 1, an input unit 2, a display unit 3, a physical probability unit 4, a camera unit 5, a processor 6, a first communication unit 7 and a second communication unit 8, wherein the processor 6 is electrically/communicatively coupled to the units 2-5 and 7-8. In this embodiment, the first communication unit 7 may be, for example, a network interface card which is directly coupled to the processor 6, and the second communication unit 8 may be, for example, a network interface card which is directly coupled to the camera unit 5 and the physical probability unit 4. The first and second communication units 7, 8 are connected to a communication network 9, and the processor 6 communicates with the camera unit 5 and the physical probability unit 4 through the first and second communication units 7, 8 and the communication network 9. In other embodiments, the gaming apparatus 100 may omit the first and second communication units 7, 8, and the processor 6 can be directly coupled to the camera unit 5 and the physical probability unit 4.

In this embodiment, the gaming apparatus 100 is configured to implement a gaming procedure including a first game and a second game, but this disclosure is not limited in this respect.

The storage unit 1 may include, for example, a hard disk drive, a flash memory, etc., to store a lookup table associated with the gaming procedure, a first total score associated with the first game, and a second total score associated with the second game. The first total score is set to have an initial first value (initial first total score) at a beginning of the gaming procedure, and the second total score is set to have an initial second value (initial second total score) at the beginning of the gaming procedure.

The input unit 2 may include, for example, at least one of a group of buttons, a keyboard, a computer mouse, or a lever, for input operation by a user.

The display unit 3 is configured to display a first gaming screen associated with the first game, and a second gaming screen associated with the second game. The display unit 3 and the input unit 2 may be integrated in a form of a touch screen.

The physical probability unit 4 is configured to randomly generate a result output based on physics principles associated with a physical structure thereof. For example, the physical probability unit 4 may include a (physical) dice, a group of (physical) bingo balls, or a (physical) roulette wheel to randomly generate a number to serve as the result output. It is particularly noted herein that the term “physical” as used herein means “actually or bodily or materially present in the physical world,” as opposed to “virtual” or “computer-generated”. The process of the physical probability unit 4 generating the result output is observable by a player of the gaming apparatus 100. In one implementation, the physical probability unit 4 may be disposed in the player's sight, physically, e.g., in the same room as the player. In another implementation, the physical probability unit 4 may be disposed remotely, with a live video recording of the physical probability unit 4 being provided for view by the player.

The camera unit 5 is used to capture an image or images of the result output generated by the physical probability unit 4.

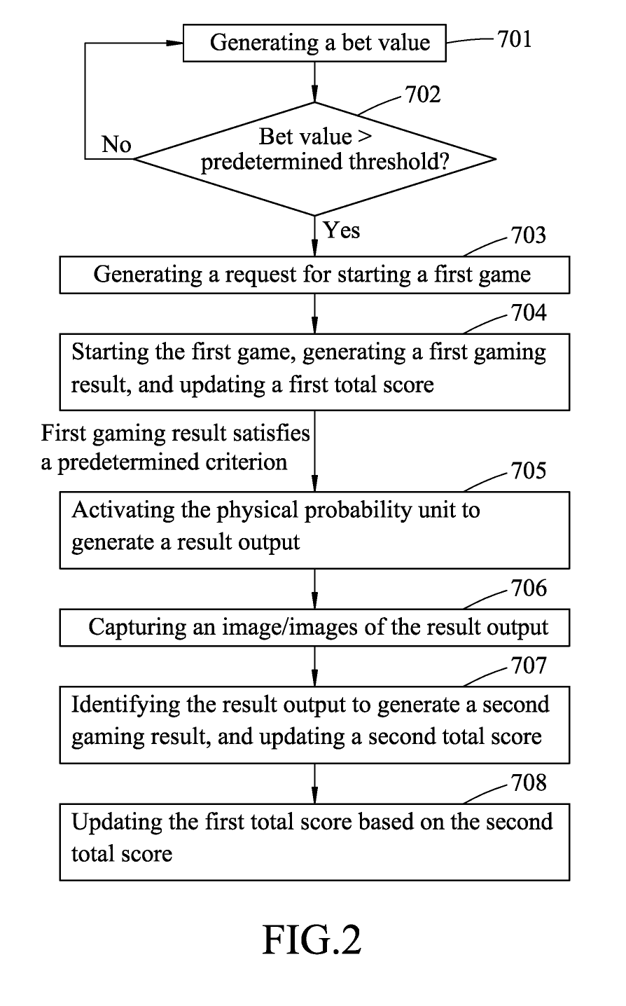

Referring to FIGS. 1 and 2, a first exemplary implementation of a gaming method according to this disclosure is shown to include steps 701 through 708. In the first exemplary implementation, the display unit 3 includes a display device that is used to display a first gaming screen associated with the first game, and display a second gaming screen associated with the second game. In other embodiments, the display unit 3 may include two display devices to respectively display the first and second gaming screens, but this disclosure is not limited in this respect.

In step 701, the input unit 2 generates a bet value in response to a user input performed thereon.

In step 702, the processor 6 determines whether the bet value is greater than a predetermined threshold in response to the input of the bet value. The flow goes to step 703 when the processor 6 determines that the bet value is greater than the predetermined threshold, and goes back to step 701 when otherwise.

In step 703, the input unit 2 generates a request for starting the first game in response to a user input performed thereon.

In step 704, the processor 6 starts a procedure of the first game in response to the request for starting the first game, followed by generating a first gaming result that is associated with the first game and that contains a first gaming score, and updating the first total score based on the first gaming score, and the display unit 3 displays the first gaming screen that contains the first gaming result and the first total score. In this implementation, the first total score is updated by adding the first gaming score to the original first total score. For example, in the first update, the first total score is updated by adding a value of the first gaming score to the initial first total score. When the first gaming result satisfies a predetermined criterion, the flow goes to step 705.

In step 705, the processor 6 starts a procedure of the second game by issuing an activation command to the physical probability unit 4 via the communication network 9 for activating the physical probability unit 4 to randomly generate the result output. In this implementation, the first game may be a slot machine game, and the predetermined criterion may be, for example, that the first gaming screen shows three identical patterns arranged in a straight line.

In step 706, the processor 6 issues a capturing command to the camera unit 5 via the communication network 9 for controlling the camera unit 5 to capture an image or images of the result output generated by the physical probability unit 4.

In some embodiments where the first and second communication units 7, 8 are omitted and the processor 6 is directly coupled to the camera unit 5 and the physical probability unit 4, the processor 6 may directly issue the activation command to the physical probability unit 4 for activating the same, and directly issue the capturing command to the camera unit 5 for controlling the same.

In step 707, the processor 6 identifies the number (i.e., the result output) generated by the physical probability unit 4 from the image or images captured by the camera unit 5, generates a second gaming result that is associated with the second game and that contains a second gaming score based on the identified number and the lookup table (LUT), and updates the second total score based on the second gaming score, and the display unit 3 displays the second gaming screen that contains the second gaming result and the second gaming score. In this implementation, in order to obtain the second gaming score, the processor 6 may first generate an LUT input based on the number identified thereby by, for example, adding the identified number to a predetermined number. Then, the processor 6 acquires an LUT output corresponding to the LUT input according to the lookup table that correlates the value of the LUT input (i.e., a sum of the identified number and the predetermined number) to a corresponding value serving as the LUT output, and multiplies the bet value with the LUT output to obtain the second gaming score. The second total score may be updated by adding the second gaming score to the original second total score. For example, in the first update, the second total score is updated by adding a value of the second gaming score to the initial second total score. In other implementations, the LUT output may be used to serve as the second gaming score directly, and this disclosure is not limited in this respect.

In step 708, the processor 6 updates the first total score based on the second total score. For example, the first total score may be updated by adding the second total score to the first total score updated in step 704, i.e., after the updating performed in step 708, the first total score would be a sum of the initial first total score, the first gaming score, the initial second total score and the second gaming score.

In one embodiment, the processor unit 6 may further generate a game repetition number corresponding to the first gaming result, and the processor 6 repeats steps 705 through 707 for a number of times equaling the gaming repetition number. For the first time the processor 6 performs step 707, the second gaming score generated the first time step 707 is performed is added to the initial second total score to obtain a first updated second total score; for the second time the processor 6 performs step 707, the second gaming score generated the second time step 707 is performed is added to the first updated second total score to obtain a second updated second total score; and similarly, for the Mth time the processor 6 performs step 707, the second gaming score generated the Mth time step 707 is performed is added to the (M−1)th updated second total score to obtain an Mth updated second total score, where M≥2.

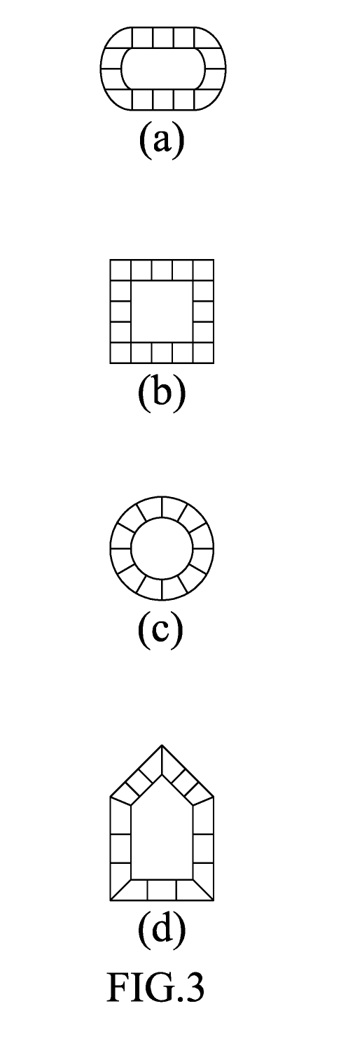

For example, the first game may be associated with a slot machine (e.g., the first game is a video slot machine), where the input unit 2 may include multiple buttons and a lever, and the first gaming screen may be a screen associated with a slot machine (e.g., the first gaming screen is a graphical representation of the computer rendered reels of the video slot machine); and the second gaming screen may include, for example, a closed loop that is divided into a plurality of segments. Referring to FIG. 3, the closed loop may be formed as a track (see part (a)), a square (see part (b)), a circle (see part (c)) or a polygon (see part (d)), in which each segment corresponds to a second gaming score (the correspondence may be included in the lookup table). At first, the user may use the buttons to determine and generate the bet value, for instance, according to instructions shown on the first gaming screen. When the processor 6 determines that the bet value is greater than the predetermined threshold, the user may use the lever to generate the request for starting the first game. In response the request, the processor 6 starts the procedure of the first game and generates the first gaming result, and updates the first total score based on the first gaming score. When the first gaming result satisfies the predetermined criterion (e.g., three identical patterns are arranged in a straight line in the first gaming screen), the processor 6 activates the physical probability unit 4 to generate the result output which is a number, and controls the camera unit 5 to capture an image or images of the result output. The processor 6 identifies the number from the image or images, and generates the second gaming result based on the identified number (which is used to obtain the LUT input) and the lookup table, where the LUT input corresponds to, for example, a target segment of the closed loop of the second game shown in the second gaming screen. For instance, the segments in the closed loop may represent different numbers in a consecutive order, and one of the segments may serve as a starting segment representing the predetermined number. Then, the processor 6 may add the identified number to the predetermined number to obtain the LUT input that corresponds to the target segment in the closed loop. The second gaming screen may show a specific object/mark/pattern moving from the starting segment, passing through a number of the segments that equals the identified number in a clockwise direction or a counterclockwise direction, and reaching the target segment. Each number represented by the respective segment may correspond to a score (i.e., the LUT output) according to the lookup table, so as to be used to acquire the second gaming score based on the target position in the closed loop. The processor 6 updates the second total score based on the second gaming score, and updates the first total score based on the second total score after completion of the second game.

In another example where the first game is associated with a slot machine, the second game may include, for example, six patterns that respectively contain numbers “1” to “6” and that respectively correspond to the six faces of a dice, respectively, and the predetermined number in this example is zero. In this case, the lookup table correlates the patterns that respectively contain numbers “1” to “6” to scores of 0, 500, 100, 1000, 200 and 200, respectively. As an example, when the result output, i.e., the result of rolling the (physical) dice, is the number “4”, the processor 6 may multiply the bet value by 1000 to obtain the second gaming score, and then update the second total score based on the second gaming score.

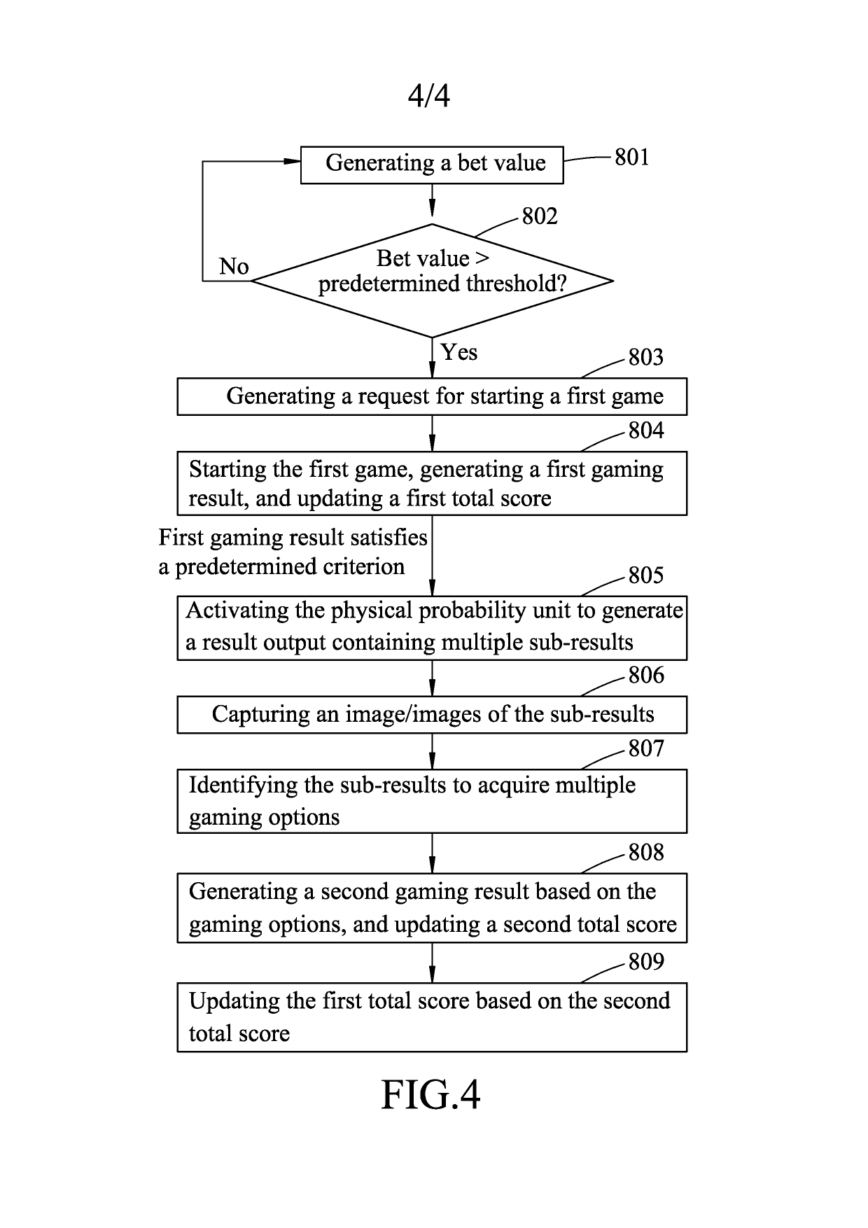

Referring to FIGS. 1 and 4, a second exemplary implementation of a gaming method according to this disclosure is shown to include steps 801 through 809. Differences between the first and second exemplary implementations reside in that in the second exemplary implementation, the second game is associated with a card game (e.g., a poker game), and that the lookup table is not pre-stored in the storage unit 1, but is generated every time the second game starts based on a random factor of the second game, and is subsequently stored in the storage unit 1. Steps 801 to 804 and 809 may be identical to steps 701 to 704 and 708 (see FIG. 2), respectively, and are not repeated herein for the sake of brevity.

In step 805, the processor 6 starts a procedure of the second game by issuing a set of activation commands to the physical probability unit 4 via the communication network 9 for activating the physical probability unit 4 to randomly generate the result output that includes multiple sub-results. At the outset, a plurality of gaming options are randomly selected by the processor 6 for playing the second game, where the gaming options are assigned predefined serial numbers. For example, six cards of poker may be dealt by the processor 6 as the gaming options, and are respectively assigned serial numbers “1” through “6”, thereby establishing/generating the lookup table that correlates the predefined serial numbers “1” through “6” (LUT input) respectively to (ranks of) the six cards of poker (LUT output) dealt by the processor 6.

In step 806, the processor 6 issues a capturing command to the camera unit 5 via the communication network 9 for controlling the camera unit 5 to capture an image or multiple images of the result output generated by the physical probability unit 4. In one example, the physical probability unit 4 may include, for instance, multiple (physical) dices to generate multiple numbers that serve as sub-results at the same time, and the camera unit 5 may capture only one image that contains all of the sub-results. In one example, the physical probability unit 4 may generate only one sub-result at one time when the physical probability unit 4 is activated, and in this case, multiple sub-results and images that respectively contain the sub-results may be acquired by repeating steps 805 and 806.

In step 807, the processor 6 identifies the numbers generated by the physical probability unit 4 from the image or images captured by the camera unit 5, and selects, from among the gaming options, multiple ones of the gaming options whose serial numbers respectively correspond to the identified numbers to serve as gaming items. For example, with one identified number being “2”, the processor 6 selects the gaming option whose serial number is “2” (e.g., the second poker card that was dealt) to serve as a gaming item (while the rank of the second poker card is acquired by the processor 6 according to the lookup table).

In step 808, the processor 6 generates the second gaming result that is associated with the second game and that contains a second gaming score based on the gaming items, and updates the second total score based on the second gaming score.

For example, the second gaming screen may show a banker side, a player side representing the user, and six randomly dealt cards of poker (gaming options) which face down and each of which has a serial number (e.g., an individual one of numbers “1” to “6”, which correspond to the faces of a dice) shown on its back. The lookup table is then generated by the processor 6 to correlate the serial numbers “1” to “6” to ranks of the dealt cards of poker, respectively. In the second game, the physical probability unit 4 may be used to generate four different sub-results (i.e., four different numbers), and the camera unit 5 is controlled to capture an image or images of the sub-results. The processor 6 identifies the sub-results from the image or images to obtain the four different numbers, followed by assigning two of the six dealt cards whose serial numbers respectively correspond to two of the identified numbers to the player side to serve as gaming items for the player side, and assigning another two of the six dealt cards whose serial numbers respectively correspond to the other two of the identified numbers to the banker side to serve as gaming items for the banker side. The processor 6 acquires ranks of the gaming items according to the lookup table, and generates the second gaming result based on the ranks of the gaming items (i.e., the four dealt cards assigned to the banker side and the player side). The display unit 3 displays the rank (or both the rank and suit) of each of the assigned cards of the banker side and the player side. In this example, the processor 6 calculates, for each of the banker side and the player side, a sum of points represented by the assigned cards, selects a units digit of the sum to serve as a comparison number for comparison with that of the other side, where each playing card that has a rank of “J”, “Q” or “K” represents 10 points, each playing card that has a rank of “A” represents 1 point, and playing cards that have ranks of “2” to “10” respectively represent 2 to 10 points. The processor 6 determines the side which has the greater comparison number as the winner of the second game, and generates the second gaming result accordingly. When the player side wins the second game, the processor 6 may determine the second gaming score to be a predetermined first score value, such as 1000; and when the banker side wins the second game, the processor 6 may determine the second gaming score to be a predetermined second score value, such as zero.

In one example where the dealt cards are “club 2” (serial number “1”), “club 8” (serial number “2”), “diamond 6” (serial number “3”), “spade K” (serial number “4”), “club 9” (serial number “5”) and “heart 10” (serial number “6”), when the (identified) numbers generated by the physical probability unit 4 are 2, 6, 4, 3 in sequence, the processor 6 may assign the dealt cards that correspond to the first two identified numbers, which are “club 8” and “heart 10”, to the player side, and assign the dealt cards that correspond to the last two identified number, which are “spade K” and “diamond 6”, to the banker side. Accordingly, since the comparison number of the player side is 8, and the comparison number of the banker side is 6, the player side wins the second game and the processor 6 determines the second gaming score to be 1000.

In summary, the gaming apparatus 100 of this disclosure includes the physical probability unit 4 to randomly generate the result output based on physics principles associated with the physical structure thereof, so the user may directly observe the process of generating the result output. Therefore, the game procedure may be performed in a variety of ways by utilizing computational technology while maintaining the excitement by involvement of the physical probability unit 4, which also conveys a sense of fairness to the players.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A gaming method to be implemented by a gaming apparatus that includes an input unit, a display unit, a processor, a camera unit, a storage unit, and a physical probability unit, the storage unit storing a first total score associated with a first game, and a second total score associated with a second game, said method comprising:
step (a): in response to a bet value inputted via the input unit, the processor determining whether the bet value is greater than a predetermined threshold;
step (b): when the processor determining that the bet value is greater than the predetermined threshold, the processor starting a procedure of the first game in response to a request for starting the first game from the input unit, followed by generating a first gaming result that is associated with the first game and that contains a first gaming score, and updating the first total score based on the first gaming score;
step (c): the processor starting a procedure of the second game by activating the physical probability unit to randomly generate a result output based on physics principles associated with a physical structure thereof;
step (d): the processor controlling the camera unit to capture an image or images of the result output generated by the physical probability unit;
step (e): the processor generating a second gaming result that is associated with the second game and that contains a second gaming score based on the image or images captured in step (d), controlling the display unit to display the second gaming result, and updating the second total score based on the second gaming score; and
step (f): the processor updating the first total score based on the second total score.

2. The gaming method of claim 1, wherein, in step (c), the processor starts the procedure of the second game only when the first gaming result generated in step (b) satisfies a predetermined criterion.

3. The gaming method of claim 1, further comprising the processor generating a game repetition number corresponding to the first gaming result, and repeating steps (c), (d) and (e) for a number of times equaling the game repetition number.

4. The gaming method of claim 1, the physical probability unit including at least one of a dice, a group of bingo balls or a roulette wheel to randomly generate a number that serves as the result output, and the storage unit further storing a lookup table (LUT) that correlates a value of an LUT input to a corresponding value serving as an LUT output;
wherein step (e) includes the processor identifying the number generated by the physical probability unit from the image or images captured in step (d), and generating the LUT input based on the number identified thereby;
wherein step (e) further includes acquiring the second gaming score based on at least the LUT output that corresponds to the LUT input according to the lookup table, and generating the second gaming result that includes the second gaming score.

5. The gaming method of claim 4, wherein the processor generates the LUT input by adding the number identified thereby to a predetermined number.

6. The gaming method of claim 1, the storage unit further storing a lookup table (LUT) that correlates a value of an LUT input to a corresponding data piece serving as an LUT output, wherein the result output generated by the physical probability unit includes a plurality of sub-results;
wherein step (e) includes: the processor identifying numbers which correspond to the sub-results from the image or images captured in step (d) and each of which serves as the LUT input; the processor acquiring, based on the numbers identified thereby and the lookup table, gaming items which respectively correspond to the numbers identified thereby and each of which serves as the LUT output correlated to a corresponding one of the numbers that serves as the LUT input from a plurality of gaming options; acquiring the second gaming score based on the gaming items; and generating the second gaming result that includes the second gaming score.

7. The gaming method of claim 1, the gaming apparatus further including a first communication unit that is electrically coupled to the processor and that is connected to a communication network, and a second communication unit that is electrically coupled to the camera unit and the physical probability unit and that is connected to the communication network, wherein step (c) includes the processor issuing an activation command to the physical probability unit via the communication network to activate the physical probability unit, and step (d) includes the processor issuing a capturing command to the camera unit via the communication network to control the camera unit.

8. A gaming apparatus comprising:
a storage unit that stores a first total score associated with a first game, and a second total score associated with a second game;
an input unit for input operation by a user;
a physical probability unit configured to randomly generate a result output based on physics principles associated with a physical structure thereof;
a camera unit configured to capture the result output generated by said physical probability unit;
a display unit; and
a processor electrically coupled to said storage unit, said input unit, said physical probability unit, said camera unit and said display unit, said processor being configured to:
in response to a bet value inputted via said input unit, determine whether the bet value is greater than a predetermined threshold;
upon determining that the bet value is greater than the predetermined threshold, start a procedure of the first game in response to a request for starting the first game from said input unit, followed by generating a first gaming result that is associated with the first game and that contains a first gaming score, and updating the first total score based on the first gaming score;
start a procedure of the second game by activating said physical probability unit to randomly generate the result output;
generate a second gaming result that is associated with the second game and that contains a second gaming score based on the image or images captured by said camera unit, control said display unit to display the second gaming result, and update the second total score based on the second gaming score; and
update the first total score based on the second total score.

9. The gaming apparatus of claim 8, wherein said processor is configured to start the procedure of the second game only when the first gaming result satisfies a predetermined criterion.

10. The gaming apparatus of claim 8, wherein said physical probability unit includes at least one of a dice, a group of bingo balls or a roulette to randomly generate a number that serves as the result output.

11. The gaming apparatus of claim 10, wherein said storage unit further stores a lookup table (LUT) that correlates a value of an LUT input to a corresponding value serving as an LUT output;
wherein said processor is further configured to identify the number generated by said physical probability unit from the image or images captured by said camera unit, and to generate the LUT input based on the number identified thereby; and
wherein said processor is further configured to acquire the second gaming score based on at least the LUT output that corresponds to the LUT input according to the lookup table, and to generate the second gaming result that includes the second gaming score.

12. The gaming apparatus of claim 11, wherein said processor is further configured to generate the LUT input by adding the number identified thereby to a predetermined number.

13. The gaming apparatus of claim 8, wherein said storage unit further stores a lookup table (LUT) that correlates a value of an LUT input to a corresponding data piece serving an LUT output;
wherein the result output generated by said physical probability unit includes a plurality of sub-results;
wherein said processor is further configured: to identify numbers which correspond to the sub-results from the image or images captured by said camera unit and each of which serves as the LUT input; to acquire, according to the numbers identified thereby and the lookup table, gaming items which respectively correspond to numbers identified thereby and each of which serves as the LUT output correlated to a corresponding one of the numbers that serves as the LUT input from a plurality of gaming options; to acquire the second gaming score based on the gaming items; and to generate the second gaming result that includes the second gaming score.

14. The gaming apparatus of claim 8, wherein said processor is further configured to generate a game repetition number corresponding to the first gaming result, and repeating specific operations for a number of times equaling the game repetition number, wherein the specific operations include, for each repetition: starting the procedure of the second game; controlling said camera unit to capture an image or images of the result output that corresponds to the repetition; generating the second gaming result corresponding to the repetition; controlling said display unit to display the second gaming result corresponding to the repetition; and updating the second total score based on the second gaming score of the second gaming result corresponding to the repetition.

15. The gaming apparatus of claim 8, further comprising a first communication unit that is electrically coupled to said processor and that is configured for connection to a communication network, and a second communication unit that is electrically coupled to said camera unit and said physical probability unit and that is configured for connection to the communication network, wherein said processor is configured to issue an activation command to said physical probability unit via the communication network to activate said physical probability unit, and to issue a capturing command to said camera unit via the communication network to control said camera unit.
